(19) United States
(12) Patent Application Publication
(10) Pub. No.: US 2024/0174910 A1
(43) Pub. Date: May 30, 2024

(54) ISOCYANATE-AMINE-BASED CHEMICAL ANCHOR WITH IMPROVED PERFORMANCE, AND USE THEREOF

(71) Applicant: Hilti Aktiengesellschaft, Schaan (LI)

(72) Inventors: Christian PLENK, Kaufering (DE); Memet-Emin KUMRU, Augsburg (DE); Thomas BÜRGEL, Landsberg (DE)

(73) Assignee: Hilti Aktiengesellschaft, Schaan (LI)

(21) Appl. No.: 18/550,324

(22) PCT Filed: Mar. 4, 2022
(86) PCT No.: PCT/EP2022/055588

§ 371 Date: Sep. 13, 2023

(30) Foreign Application Priority Data
Mar. 16, 2021 (EP) 21162918.3

(51) Int. Cl. C09K 8/44; C08G 18/38; C08G 18/72; C08G 18/73; C08G 18/78; C08K 3/34; C08K 3/36; C08K 5/5435; C08K 13/02; E04B 1/38; F16B 13/14

(52) U.S. Cl. CPC C09K 8/44; C08G 18/3865; C08G 18/725; C08G 18/73; C08G 18/7831; C08K 13/02; E04B 1/38; C08K 2003/343; C08K 3/36; C08K 5/5435; F16B 2013/147

(57) ABSTRACT

A multi-component resin system can be used for producing a mortar composition based on isocyanate amine adducts for the chemical fastening of construction elements. A mortar composition based on isocyanate amine adducts is produced from the multi-component resin system. The mortar composition based on the isocyanate amine adducts is useful for the chemical fastening of construction elements in mineral substrates.

The present invention relates to a multi-component resin system for producing a mortar composition based on isocyanate amine adducts for the chemical fastening of construction elements. The invention also includes a mortar composition based on isocyanate amine adducts produced from the multi-component resin system. The present invention also relates to a method for the chemical fastening of construction elements in mineral substrates and to the use of a mortar composition based on the isocyanate amine adducts for the chemical fastening of construction elements in mineral substrates.

Binder systems based on radically curing compounds such as methacrylate resins or based on epoxy resins reacted with amine curing agents are usually used to produce mortar compositions for the chemical fastening of construction elements, such as anchor rods, reinforcing bars and screws in boreholes. There are numerous commercially available products based on these binder systems.

However, the known binder systems have inadequate properties, especially under critical external conditions, such as elevated temperatures, uncleaned boreholes, damp or water-filled boreholes, diamond-drilled boreholes, boreholes in cracked concrete, etc.

In addition to developing and improving the existing binder systems, efforts are therefore also being made to examine binder systems other than those mentioned above with regard to their suitability as a basis for mortar compositions for chemical fastening. For example. EP 3 447 078 A1 describes a chemical anchor which is produced from a multi-component composition which comprises a polyisocyanate component and a polyaspartic add ester component. When the two components are mixed, polyurea is formed in a polyaddition reaction, which forms the binder of the mortar composition.

These mortar compositions are disadvantageous in that the polyaspartic acid esters used lead to insufficient cross-linking and become highly softened already at temperatures of 80° C., and therefore do not perform well at high temperatures. In addition, the cured test specimens are not base stable.

In order to overcome these disadvantages, a mufti-component resin system was developed which, proceeding from EP 3 447 078 A1, uses an amine having an average NH functionality of 2 or more instead of the polyaspartic acid ester, as described in the unpublished European patent application no. 20 164 633.8.

However, this system does not yet provide the high loads required for some purposes and applications in chemical fastening.

There is therefore also need for mortar compositions based on isocyanate amine adducts which perform better, that is to say which have high pull-out values and load values, by comparison with the systems known from application EP 20 164 633.8.

The object of the present invention is therefore to provide a mortar composition based on isocyanate amine adducts which provides for improved pull-out strength, that is to say higher pull-out values, and is therefore suitable for fastening purposes at high loads.

The object of the invention is achieved by providing a multi-component resin system according to claim 1. Preferred embodiments of the multi-component resin system according to the invention are provided in the dependent claims, which may optionally be combined with one another.

The invention also relates to a mortar composition according to claim 14 which is intended for the chemical fastening of construction elements and is produced from the mufti-component resin system according to the invention.

The invention also relates to a method according to claim 15 for the chemical fastening of construction elements in mineral substrates, to the use of a molecular sieve in a multi-component resin system based on isocyanate amine adducts according to claim 16 for chemical fastening in order to increase the pull-out values of a chemical anchor and to the use of the multi-component resin system according to the invention or the mortar composition produced therefrom according to claim 17 for the chemical fastening of construction elements in mineral substrates.

The Invention firstly relates to a multi-component resin system containing an isocyanate component which comprises at least one aliphatic and/or aromatic polyisocyanate having an average NCO functionality of 2 or more, and an amine component which comprises at least one amine which is reactive to isocyanate groups and has an average NH functionality of 2 or more, with the proviso that the multi-component resin system is free of polyaspartic acid esters, the isocyanate component and/or the amine component comprising at least one filler and at least one rheology additive and the total filling level of a mortar composition produced by mixing the isocyanate component and the amine component being in a range from 30 to 80%, characterized in that the isocyanate component and/or the amine component contains a molecular sieve.

It has been found that the presence of polyaspartic acid esters in isocyanate-amine-based binder systems used in mortar compositions for chemical fastening has a negative influence on the temperature resistance of the cured mortar compositions. In particular, corresponding systems have a greatly reduced bond stress at elevated temperatures, such as 80° C.

It is also essential that the multi-component resin system and in particular the amine component of the multi-component resin system be free of polyaspartic acid esters. The expression “free of polyaspartic acid esters” in the context of the present application means that the proportion of polyaspartic acid esters in the multi-component resin system is preferably less than 2 wt. %. more preferably less than 0.5 wt. % and even more preferably less than 0.1 wt. %. based in each case on the total weight of the multi-component resin system. The presence of polyaspartic acid esters in the aforementioned weight percentage ranges can be attributed to potential impurities. The proportion of polyaspartic acid esters in the multi-component resin system is, however, particularly preferably 0.0 wt. %. based on the total weight of the multi-component resin system.

For better understanding of the invention, the following explanations of the terminology used herein are considered to be useful. Within the meaning of the invention:
A “multi-component resin system” is a reaction resin system that comprises a plurality of components stored separately from one another, generally the resin component and the hardener component, so that curing takes place only after all components have been mixed.
“Isocyanates” are compounds that have a functional isocyanate group —N═C═O and are characterized by the structural unit R—N═C═O.
“Polyisocyanates” are compounds that have at least two functional isocyanate groups —N═C═O: diisocyanates, which are also covered by the definition of polyisocyanate, are characterized, for example, by the structure O═C═N—R—N═C═O and thus have an NCO functionality of 2.
“Average NCO functionality” describes the number of isocyanate groups in the compound: in the case of a mixture of isocyanates, the “averaged NCO functionality” describes the averaged number of isocyanate groups in the mixture and is calculated according to the formula: averaged NCO functionality (mixture)=Σ average NCO functionality (isocyanate i)/nᵢ, i.e. the sum of the average NCO functionality of the individual components divided by the number of individual components.
“Isocyanate component” or also A component is a component of the multi-component resin system which comprises at least one polyisocyanate and optionally at least one filler and/or at least one rheology additive and/or further additives.
“Amines” are compounds which have a functional NH group, are derived from ammonia by replacing one or two hydrogen atoms with hydrocarbon groups and have the general structures RNH₂ (primary amines) and R₂NH (secondary amines) (see: IUPAC Compendium of Chemical Terminology, 2nd ed. (the “Gold Book”), compiled by A. D. McNaught and A. Wilkinson. Blackwell Scientific Publications. Oxford (1997)). The compound class of polyaspartic acid esters is explicitly excluded from the term amines in the context of the present inventions. These are defined separately under the term polyaspartic acid esters.
“NH functionality” describes the number of active hydrogen atoms that can react with an isocyanate group in an amino group.
“Average NH functionality” describes the number of active hydrogen atoms that can react with an isocyanate group in an amine and results from the number and NH functionality of the amino groups contained in the compound. i.e. the amine: in the case of a mixture of amines, the averaged NH functionality describes the averaged number of active hydrogen atoms in the mixture and is calculated according to the formula: averaged NH functionality (mixture)=Σ average NH functionality (amine i)/nᵢ, i.e. the sum of the average NH functionality of the individual components divided by the number of individual components.
The term “polyaspartic acid esters” refers to compounds of the general formula:

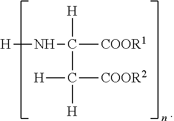

in which
   R¹ and R² can be the same or different and represent an organic group which is inert to isocyanate groups.
   X represents an n-valent organic group which is inert to isocyanate groups, and
   n represents an integer of at least 2, preferably from 2 to 6, more preferably from 2 to 4 and particularly preferably 2.
“amine component” or also B component is a component of the multi-component resin system which comprises at least one amine and optionally at least one filler and/or at least one rheology additive and/or further additives.
“Isocyanate amine adducts” are polymers that are formed by the polyaddition reaction of isocyanates with amines. The isocyanate amine adducts according to the invention are preferably polyureas which comprise at least one structural element of the form—[—NH—R—NH—NH—R′—NH—].
“Aliphatic compounds” are acyclic or cyclic, saturated or unsaturated carbon compounds, excluding aromatic compounds.
“Alicyclic compounds” are compounds having a carbocyclic ring structure, excluding benzene derivatives or other aromatic systems.
“Araliphatic compounds” are aliphatic compounds having an aromatic backbone such that, in the case of a functionalized araliphatic compound, a functional group that is present is bonded to the aliphatic rather than the aromatic part of the compound.
“Aromatic compounds” are compounds which follow Hückel's rule (4n+2).
A “two-component reaction resin system” means a reaction resin system that comprises two separately stored components, in the present case an isocyanate component and an amine component, so that curing takes place only after the two components have been mixed.
The term “mortar composition” refers to the composition that is obtained by mixing the isocyanate component and the amine component and as such can be used directly for chemical fastening.
The term “filler” refers to an organic or inorganic, in particular inorganic, compound.
The term “rheology additive” refers to additives which are able to influence the viscosity behavior of the isocyanate component, the amine component and the multi-component resin system during storage, application and/or curing. The rheology additive prevents, inter alia, sedimentation of the fillers in the polyisocyanate component and/or the amine component. It also improves the miscibility of the components and prevents possible phase separation.
The term “temperature resistance” refers to the change in the bond stress of a cured mortar composition at an elevated temperature compared with the reference bond stress. In the context of the present invention, the temperature resistance is specified in particular as the ratio of the bond stress at 80° C. to the reference stress.
“A” or “an” as the article preceding a class of chemical compounds, e.g. preceding the word “filler.” means that one or more compounds included in this class of chemical compounds, e.g. “various fillers,” may be intended.
“At least one” means numerically “one or more”; in a preferred embodiment, the term means numerically “one.”
“Contain” and “comprise” mean that more constituents may be present in addition to the mentioned constituents: these terms are meant to be inclusive and therefore also include “consist of”; “consist of” is meant exclusively and means that no further constituents may be present: in a preferred embodiment, the terms “contain” and “comprise” mean the term “consist of”.

All standards cited in this text (e.g. DIN standards) were used in the version that was current on the filing date of this application.

Isocyanate Compounds

The multi-component resin system according to the invention comprises at least one isocyanate component and at least one amine component. Before use, the isocyanate component and the amine component are provided separately from one another in a reaction-inhibiting manner.

The isocyanate component comprises at least one polyisocyanate. AN aliphatic and/or aromatic isocyanates known to a person skilled in the art and having an average NCO functionality of 2 or more, individually or in any mixtures with one another, can be used as the polyisocyanate. The average NCO functionality indicates how many NCO groups are present in the polyisocyanate. Polyisocyanate means that two or more NCO groups are contained in the compound.

Suitable aromatic polyisocyanates are those having aromatically bound isocyanate groups, such as diisocyanatobenzenes, toluene diisocyanates, diphenyl diisocyanates, diphenylmethane diisocyanates, diisocyanatonaphathalenes, triphenylmethane triisocyanates, but also those having isocyanate groups that are bound to an aromatic group via an alkylene group, such as a methylene group, such as bis- and tris-(isocyanatoalkyl) benzenes, toluenes and xylenes.

Preferred examples of aromatic polyisocyanates are: 1,3-phenylene diisocyanate, 1,4-phenylene diisocyanate, 2,4-toluylene diisocyanate, 2,5-toluylene diisocyanate, 2,6-toluylene diisocyanate, 1,3-xylylene diisocyanate, 1,4-xylylene diisocyanate, tetramethyl-1,3-xylylene diisocyanate, tetramethyl-1,4-xylylene diisocyanate, 1,3-bis(isocyanatomethyl)benzene, 1,4-bis(isocyanatomethyl)benzene, ethylphenyl diisocyanate, 2-dodecyl-1,3-phenylene diisocyanate, 2,4,6-triisopropyl-m-phenylene diisocyanate, 2,4,6-trimethyl-1,3-phenylene diisocyanate, xylylene diisocyanate, 1,5-naphthylene diisocyanate, 3,3′-dimethyl-4,4′-biphenyl diisocyanate, 3,3′-dimethoxy-4,4′-biphenyl diisocyanate, 3,3′-dimethyl-4,4′-biphenyl diisocyanate, diphenylene methane-2,4′-diisocyanate, diphenylene methane-2,2-diisocyanate, diphenylene methane-4,4′-diisocyanate, triphenylmethane-4,4′,4″-triisocyanate, 5-(p-isocyanatobenzyl)-2-methyl-m-phenylene diisocyanate, 4,4-diisocyanato-3,3,5,5-tetraethyldiphenylmethane, 5,5′-ureylene di-o-tolyl diisocyanate, 4-{(5-isocyanato-2-methylphenyl)methyl}-m-phenylene diisocyanate, 4-[(3-isocyanato-4-methylphenyl)methyl]-m-phenylene diisocyanate, 2,2′-methylene-bis[6-(o-isocyanatobenzyl)phenyl]diisocyanate.

Aliphatic isocyanates which have a carbon backbone (without the NCO groups contained) of 3 to 30 carbon atoms, preferably 4 to 20 carbon atoms, are preferably used. Examples of aliphatic polyisocyanates are bis(isocyanatoalkyl) ethers or alkane diisocyanates such as methane diisocyanate, propane diisocyanates, butane diisocyanates, pentane diisocyanates, hexane diisocyanates (e.g. hexamethylene diisocyanate, HDI), heptane diisocyanates (e.g. 2,2-dimethylpentane-1,5-diisocyanate, octane diisocyanates, nonane diisocyanates (e.g. trimethyl HDI (TMDI) usually as a mixture of the 2,4,4- and 2,2,4-isomers), 2-methylpentane-1,5-diisocyanate (MPDI), nonane triisocyanates (e.g. 4-isocyanatomethyl-1,8-octane diisocyanate, 5-methylnonane diisocyanate), decane diisocyanates, decane triisocyanates, undecane diisocyanates, undecane triisocyanates, dodecane diisocyanates, dodecane triisocyanates, 1,3- and 1,4-bis-(isocyanatomethyl)cyclohexane (H₆XDI), 3-isocyanatomethyl-3,5,5-trimethylcyclohexyl isocyanate (isophorone diisocyanate, IPDI), bis-(4-isocyanatocyclohexyl)methane (H₁₇MDI), bis-(isocyanatomethyl)norbornane (NBDI) or 3(4)-isocyanatomethyl-1-methyl-cyclohexyl isocyanate (IMCI), octagydro-4,7-methano-1H-indenedimethyl diisocyanate, norbornene diisocyanate, 5-isocyanato-1-(isocyanatomethyl)-1,3,3-trimethylcyclohexane, ureylene-bis(p-phenylenemethylene-p-phenylene)diisocyanate.

Particularly preferred isocyanates are hexamethylene diisocyanate (HDI), trimethyl HDI (TMDI), pentane diisocyanate (PDI), 2-methylpentane-1,5-diisocyanate (MPDI), isophorone diisocyanate (IPDI), 1,3- and 1,4-bis-(isocyanatomethyl)cyclohexane (H₆XDI), bis-(isocyanatomethyl)norbornane (NBDI), 3(4)-isocyanatomethyl-1-methyl-cyclohexyl isocyanate (IMCI) and/or 4,4′-bis(isocyanatocyclohexyl)methane (H₁₂MDI) or mixtures of these isocyanates.

Even more preferably, the polyisocyanates are present as prepolymers, biurets, isocyanurates, iminooxadiazinediones, uretdiones and/or allophanates, which can be produced by oligomerizing difunctional isocyanates or by reacting the isocyanate compounds with polyols or polyamines. Individually or as a mixture, and which have an average NCO functionality of 2 or more.

Examples of suitable, commercially available isocyanates are Desmodur® N 3900. Desmodur® N 100, Desmodur® Ultra N 3200, Desmodur® Ultra N 3300, Desmodur® Ultra N 3600, Desmodur® N 3800, Desmodur® XP 2675, Desmodur® 2714, Desmodur® 2731, Desmodur® N 3400, Desmodur® XP 2679, Desmodur® XP 2731, Desmodur® XP 2489, Desmodur® E 3370, Desmodur® XP 2599, Desmodur® XP 2617, Desmodur® XP 2406, Desmodur® XP 2551, Desmodur® XP 2838, Desmodur® XP 2840, Desmodur® VL, Desmodur® VL 50, Desmodur® VL 51, Desmodur® ultra N 3300, Desmodur® eco N 7300, Desmodur® E23, Desmodur® E XP 2727, Desmodur® E 30600, Desmodur® E 2863 XP, Desmodur® H, Desmodur® VKS 20 F, Desmodur®44V201, Desmodur® 44P01, Desmodur® 44V70 L, Desmodur® N3400, Desmodur® N3500 (all available from Covestro AG), Tolonate™ HDB, Tolonate™ HDB-LV, Tolonate™ HDT, Tolonate™ HDT-LV, Tolonate™ HDT-LV2 (available from Vencorex), Basonat® HB 100, Basonat® HI 100, Basonat® HI 2000 NG (available from BASF), Takenate® 500, Takenate® 600, Takenate® D-132N(NS). Stabio® D-376N (all available from Mitsui), Duranate® 24A-100, Duranate® TPA-100. Duranate® TPH-100 (all available from Asahi Kasai). Coronate® HXR, Coronate® HXLV, Coronate® HX, Coronate® HK (all available from Tosoh).

One or more polyisocyanates are contained in the isocyanate component preferably in a proportion of from 20 to 100 wt. %. more preferably in a proportion of from 30 to 90 wt. % and even more preferably in a proportion of from 35 to 65 wt. %, based on the total weight of the isocyanate component.

Amine Compounds

The amine component, which is provided separately from the isocyanate component in the multi-component resin system in a reaction-inhibiting manner, comprises at least one amine which is reactive to isocyanate groups and comprises an amino group, preferably at least two amino groups, as functional groups. According to the invention, the amine has an average NH functionality of 2 or more. The average NH functionality indicates the number of hydrogen atoms bonded to a nitrogen atom in the amine. Accordingly, for example, a primary monoamine has an average NH functionality of 2, a primary diamine has an average NH functionality of 4, an amine having 3 secondary amino groups has an average NH functionality of 3 and a diamine having one primary and one secondary amino group has an average NH functionality of 3. The average NH functionality can also be based on the information provided by the amine supplier, the NH functionality actually indicated possibly differing from the theoretical average NH functionality as it is understood here. The expression “average” means that it is the NH functionality of the compound and not the NH functionality of the amino group(s) contained in the compound. The amino groups can be primary or secondary amino groups. The amine can contain either only primary or only secondary amino groups, or both primary and secondary amino groups.

According to a preferred embodiment, the amine which is reactive to isocyanate groups is selected from the group consisting of aliphatic, alicyclic, araliphatic and aromatic amines, particularly preferably from the group consisting of alicyclic and aromatic amines.

Amines which are reactive to isocyanate groups are known in principle to a person skilled in the art. Examples of suitable amines which are reactive to isocyanate groups are given below, but without restricting the scope of the invention. These can be used either individually or in any mixtures with one another. Examples are: 1,2-diaminoethane(ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), 1,3-benzenedimethanamine (m-xylylenediamine, mXDA), 1,4-benzenedimethanamine (p-xylylenediamine, pXDA), 5-(aminomethyl)bicyclo[[2.2.1]hept-2-yl]methylamine (NBDA, norbornane diamine), dimethyldipropylenetriamine, dimethylaminopropylaminopropylamine (DMAPAPA), 2,4-diamino-3,5-dimethylthiotoluene (dimethylthio-toluene diamine DMTDA), 3-aminomethyl-3,5,5-trimethylcyclohexyl amine (isophorone diamine (IPDA)), diaminodicyclohexylmethane (PACM), diethylmethylbenzenediamine (DETDA), 3,3-diaminodiphenylsulfone (33 dapsone), 4,4′-diaminodiphenylsulfone (44 dapsone), mixed polycyclic amines (MPCA) (e.g. Ancamine 2168), dimethyldiaminodicyclohexylmethane (Laromin C260), 2,2-bis(4-aminocyclohexyl)propane. (3(4),8(9)bis(aminomethyldicyclo(5.2.1.0^{2,6})decane (mixture of isomers, tricyclic primary amines: TCD diamine), methylcyclohexyl diamine (MCDA). N,N′-diaminopropyl-2-methyl-cyclohexane-1,3-diamine. N,N′-diaminopropyl-4-methyl-cyclohexane-1,3-diamine, N-(3-aminopropyl)cyclohexylamine, and 2-(2,2,6,6-tetramethylpiperidin-4-yl)propane-1,3-diamine.

Particularly preferred amines are diethylmethylbenzenediamine (DETDA), 2,4-diamino-3,5-dimethylthiotoluene (dimethylthio-toluene diamine, DMTDA), 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine (Ethacure® 300), 4,4′-methylenebis(2,6-diethylaniline), 4,4′-methylenebis(N-sec-butylcyclohexanamine) (Clearlink® 1000), 3,3′-diaminodiphenylsulfone (33 dapsone), 4,4′-diaminodiphenylsulfone (44 dapsone), N,N′-di-sec-butyl-p-phenylenediamine and 2,4,6-trimethyl-m-phenylenediamine, 4,4′-methylenebis(N-(1-methylpropyl)-3,3′-dimethylcyclohexanamine (Clearlink® 3000), the reaction product of 2-propenenitrile with 3-amino-1,5,5-trimethylcyclohexanemethanamine (Jefflink® 745) and 3-((3-(((2-cyanoethyl)amino)methyl)-3,5,5-trimethylcyclohexyl)amino)propiononitrile (Jefflink® 136 or Baxxodur® PC136).

Most particularly preferred amines are 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine (Ethacure® 300), 4,4′-methylenebis(2,6-diethylaniline), 4,4′-methylenebis(N-sec-butylcyclohexanamine) (Clearlink® 1000), 3,3′-diaminodiphenylsulfone (33 dapsone), N,N′-di-sec-butyl-p-phenylenediamine and 2,4,6-trimethyl-m-phenylenediamine.

One or more amines are contained in the amine component preferably in a proportion of from 20 to 100 wt. %. more preferably in a proportion of from 30 to 70 wt. % and even more preferably in a proportion of from 35 to 70 wt. %, based on the total weight of the amine component.

The quantity ratios of the polyisocyanate and the amine of the multi-component resin system are preferably selected such that the ratio of the average NCO functionality of the polyisocyanate to the average NH functionality of the amine is between 0.3 and 2.0, preferably between 0.5 and 1.8, more preferably between 0.5 and 1.5, even more preferably between 0.7 and 1.5 and most preferably 0.7 to 1.3.

A mixture of different polyisocyanates and/or different amines can be used to adjust the rate of curing. In this case, their quantity ratios are selected such that the ratio of the averaged NCO functionality of the isocyanate mixture to the averaged NH functionality of the amine mixture is between 0.3 and 2.0, preferably between 0.5 and 1.8, more preferably between 0.5 and 1.5, even more preferably between 0.7 and 1.5 and most preferably between 0.7 and 1.3.

Fillers and Additives

According to the invention, the multi-component resin system contains a molecular sieve, in particular a zeolite as a filler, for increasing the performance (pull-out values) of the multi-component resin system.

The zeolites used in the present invention can be synthetic or natural zeolites and are generally characterized by the composition Mⁿ⁺_{x/n}[(AlO)⁻ₓ(SiO₂)ᵥ]·zH₂O, where N is the charge of M, usually 1 or 2, and M is a cation of an alkali or alkaline earth metal, in particular Na⁺, K⁺, Ca²⁺ and Mg²⁺.

The following can be used as zeolites:
zeolte A (Na₁₂((AlO₂)₁₂(SiO₂)₁₂)·27 H₂O: K₁₂((AlO₂)₁₂(SiO₂)₁₂)·27 H₂O),
zeolite X (Na₈₆[(AlO₂)₈₆(SiO₂)₁₀₆]·264 H₂O),
zeolite Y (Na₅₆[(AlO₂)₅₆(SiO₂)₁₃₆]·250 H₂O),
zoolite L (K₉[(AlO₂)₉(SiO₂)₂₇]·22 H₂O),
mordenite (Na_{8 7}[(AlO₂)_{8 7}(SiO₂)_{39 3}]·24 H₂O),
zeolite ZSM 5 (Na_{0.3}H_{3.8}[(AlO₂)_{4.1}(SiO₂)_{91 9}]),
zeolite ZSM 11 (Na_{0.1}H_{1 7}[(AlO₂)_{1 8}(SiO₂)_{94.2}]). Of these, zeolite A, zeolite X, zeolite Y and
zeolite ZSM 5 and zeolite ZSM 11 are preferred.

The molecular sieve, in particular the zeolite, can be used as a powder, granular material or as a paste (for example 48-50% powder dispersed in castor oil) The synthetic zeolite is preferably a synthetic zeolite comprising particles having a particle size of up to 250 μm, in particular from 5 μm to 24 μm. The synthetic zeolite particularly preferably has a pore size of approximately 5 Å to approximately 10 Å, in particular approximately 3 Å to approximately 4 Å.

The specific surface area (BET) of the zeolite particles is preferably between 800 m²/g and 1000 m²/g.

The residual water content of the zeolite is below 2.5% w/w, preferably below 1.5% w/w, and the water absorption capacity is below 22-24% w/w.

It is possible to use a mixture of two or more different types of zeolite.

The molecular sieve, in particular the zeolite, is preferably used in an amount of from 0.1 to 60 wt. %, particularly preferably in an amount of from 1 to 35 wt. % and very particularly preferably in an amount of from 2 to 5 wt. %. based on the total weight of the multi-component resin system.

By using the molecular sieve, the performance (load level) of a cured isocyanate-amine-based chemical anchor mass could be increased by 5 to 10% compared with an anchor mass which does not contain a molecular sieve.

The molecular sieve can be contained in one of the two components of the multi-component resin system or in both components.

The molecular sieve can also serve as a drying agent for the isocyanate component and can thus improve the storage stability of the isocyanate component and thus of a multi-component resin system which comprises the isocyanate component.

If the molecular sieve is used as a drying agent, the isocyanate component contains the molecular sieve or at least part thereof, the minimum amount in which the molecular sieve is contained in the isocyanate component being 3 wt. %, based on the weight of the isocyanate component. In particular, if an additional increase in storage stability is desired, the molecular sieve is contained in the isocyanate component in an amount of 3 wt. % to 35 wt. %. preferably 3 wt. % to 20 wt. %, and particularly preferably 3 wt. % to 5 wt. %. based in each case on the weight of the isocyanate component.

In addition to the molecular sieve, the isocyanate component and/or the amine component according to the invention contain at least one filer and at least one rheology additive, it being essential to the invention that at least one of the two components contains both a filer and a rheology additive. It is preferable for both the isocyanate component and the amine component to each contain at least one filler and at least one rheology additive.

The total filing level of a mortar composition. Including the molecular sieve, produced by mixing the isocyanate component and the amine component of the multi-component resin system is, according to the invention, in a range from 30 to 80 wt. %. based on the total weight of the mortar composition, preferably in a range from 35 to 65 wt. %. more preferably in a range from 35 to 60 wt. %. The total filing level of the mortar composition relates to the percentage by weight of filler, including the molecular sieve, and rheology additive based on the total weight of the isocyanate component and the amine component. In a preferred embodiment, the fining level of the isocyanate component is up to 80 wt. %. preferably from 10 to 70 wt. %, more preferably from 35 to 65 wt. %. based on the total weight of the isocyanate component. The filling level of the amine component is preferably up to 80 wt. %, more preferably from 10 to 70 wt. %, even more preferably from 35 to 65 wt. %. based in each case on the total weight of the amine component.

Inorganic fillers, in particular cements such as Portland cement or aluminate cement and other hydraulically setting inorganic substances, quartz, glass, corundum, porcelain, earthenware, barite, light spar, gypsum, talc and/or chalk and mixtures thereof are preferably used as filers. The inorganic fillers can be added in the form of sands, powders, or molded bodies, preferably in the form of fibers or balls. A suitable selection of the filers with regard to type and particle size distribution/(fiber) length can be used to control properties relevant to the application, such as rheological behavior, press-out forces, internal strength, tensile strength, pull-out forces and impact strength. Particularly suitable fillers are quartz powders, fine quartz powders and ultra-fine quartz powders that have not been surface-treated, such as Millisil® W3. Millisil® W6, Millisil® W8 and Millisil® W12, preferably Millisl® W12. Silanized quartz powders, fine quartz powders and ultra-fine quartz powders can also be used. These are commercially available, for example, from the Silbond® product series from Quarzwerke. The product series Silbond® EST (modified with epoxysilane) and Silbond® AST (treated with aminosilane) are particularly preferred. Furthermore, it is possible for fillers based on aluminum oxide such as aluminum oxide ultra-fine filers of the ASFP type from Denka, Japan (d50=0.3 μm) or grades such as DAW or DAM with the type designations 45 (d50<0.44 μm), 07 (d50>8.4 μm), 05 (d50<5.5 μm) and 03 (d50<4.1 μm). Moreover, the surface-treated fine and ultra-fine filers of the Aktisil AM type (treated with aminosilane, d50=2.2 μm) and Aktisil EM (treated with epoxysilane, d50=2.2 μm) from Hoffman Mineral can be used. The fillers can be used individually or in any mixture with one another.

The flow properties are adjusted by adding rheology additives which, according to the invention, are used in the isocyanate component and/or the amine component. Suitable rheology additives are: phylosilicates such as laponites, bentones or montmorillonite. Neuburg siliceous earth, fumed silicas, polysaccharides; polyacrylate, polyurethane or polyurea thickeners and cellulose esters. Wetting agents and dispersants, surface additives, defoamers 3 deaerators, wax additives, adhesion promoters, viscosity reducers or process additives can also be added for optimization.

The proportion of one or more theology additives in the isocyanate component is preferably from 0.1 to 3 wt. %, more preferably from 0.1 to 1.5 wt. %. based on the total weight of the isocyanate component. The proportion of one or more rheology additives in the amine component is preferably from 0.1 to 5 wt. %. more preferably from 0.5 to 3 wt. %. based on the total weight of the amine component.

In one embodiment of the multi-component resin system, the isocyanate component and/or the amine component contains at least one silane as an adhesion promoter.

By using a silane, the cross-linking of the borehole wall with the mortar composition is improved such that the adhesion increases in the cured state.

Suitable adhesion promoters are selected from the group of silanes that have at least one Si-bound hydrolyzable group. It is not necessary for the silane to comprise a further functional group in addition to the Si-bound hydrolyzable group, such as an isocyanate group or an amino group. Nevertheless. In addition to the Si-bound hydrolyzable group, the silane may comprise one or more identical or different further functional groups, such as an amino, mercapto, epoxy, isocyanato, alkenyl, (meth) acryloyl, anhydrido or vinyl group. The Si-bound hydrolyzable group is preferably a C₁-C₇ alkoxy group and very particularly preferably a methoxy or ethoxy group.

Suitable silanes are selected from the group consisting of 3-aminopropyltrialkoxysilanes such as 3-aminopropyltrimethoxysilane and 3-aminopropyltriethoxysilane; 3-glycidyloxypropyltrialkoxysilanes such as 3-glycidyloxypropyltrimethoxysilane and 3-glycidyloxypropyltriethoxysilane: glycdyloxymethyltrimethoxysilane: 3-glyadyloxypropylmethyldimethoxysilane: bis-(3-trialkoxysilylpropyl) amines such as bis-(3-trimethoxysilylpropyl) amine and bis-(3-triethoxysiylpropyl) amine; 3-mercaptopropyltrialkoxysilanes such as 3-mercaptopropyltrimethoxysilane and 3-mercaptopropylmethyldimethoxysilane 3-(meth)acryloyloxyalkyltrialkoxysilanes such as 3-(meth)acryloxypropyltrimethoxysilane, 3-(meth)acryloyloxypropyltriethoxysilane: 3-(meth)acryloyloxymethyltrimethoxysilane, 3-(meth)acryloyloxymethyltriethoxysilane and 3-(meth)acryloyloxypropylmethyldimethoxysilane; alkenylalkoxysilanes such as vinylalkoxysilanes, e.g. vinyltrimethoxysilane and vinyltriethoxysilane: tetraalkoxysilanes such as tetraethoxysilane, tetramethoxysilane and tetrapropoxysilane: 2-(3,4-epoxycyclohexyl)ethyltrimethoxysilane, N-2-(aminoethyl)-3-aminopropylmethyl-diethoxysilane, N-2-(aminoethyl)-3-aminopropyl-triethoxysilane, N-phenyl-3-aminoethyl-3-aminopropyl trimethoxysilane and mixtures of two or more thereof.

Particularly suitable silanes are selected from the group consisting of 3-aminopropyltrialkoxysilanes, 3-glycidyloxyalkyltrialkoxysilanes, bis-(3-trialkoxysilylpropyl) amines, 3-mercaptopropyltrialkoxysilanes, 3-(meth)acryloyloxyalkyltrialkoxysilanes, alkenylalkoxysilanes, tetraalkoxysilanes and mixtures of two or more thereof.

Most particularly suitable silanes are 3-glycidoxypropyldimethoxysilane, 3-glycidoxypropyltrimethoxysilane, 3-trimethoxysilylpropyl methacrylate and vinyltrimethoxysilane.

The silane can be contained in the multi-component resin system in an amount of up to 10 wt. %. preferably from 0.1 to 5 wt. %. more preferably from 1.0 to 2.5 wt. %. based on the total weight of the multi-component resin system. The silane can be contained entirely in one component, i.e. the isocyanate component or the amine component, or be split between the two components. i.e. split between the isocyanate component and the amine component.

The invention also relates to a mortar composition which is produced by mixing the isocyanate component and the amine component of the multi-component resin system.

The multi-component resin system is preferably present in cartridges or film pouches which are characterized in that they comprise two or more separate chambers in which the isocyanate component and the amine component are separately arranged in a reaction-inhibiting manner.

For the use as intended of the multi-component resin system, the isocyanate component and the amine component are discharged out of the separate chambers and mixed in a suitable device, for example a static mixer or dissolver. The mixture of isocyanate component and amine component (mortar composition) is then introduced into the optionally previously cleaned borehole by means of a known injection device. The fastening element to be fastened is then inserted into the mortar composition and aligned. The reactive constituents of the isocyanate component react with the amino groups of the amine component by polyaddition such that the mortar composition cures under environmental conditions within a desired period of time, preferably within a few minutes or hours.

The mortar composition according to the invention or the multi-component resin system according to the invention is preferably used for construction purposes. The expression “for construction purposes” refers to the structural adhesion of concrete/concrete, steel/concrete or steel/steel or one of said materials with other mineral materials, to the structural strengthening of components made of concrete, brickwork and other mineral materials, to reinforcement applications with fiber-reinforced polymers of building objects, to the chemical fastening of surfaces made of concrete, steel or other mineral materials, in particular the chemical fastening of construction elements and anchoring means, such as anchor rods, anchor bolts. (threaded) rods. (threaded) sleeves, reinforcing bars, screws and the like, in boreholes in various substrates, such as (reinforced) concrete, brickwork, other mineral materials, metals (e.g. steel), ceramics, plastics, glass, and wood. Most particularly preferably, the mortar compositions according to the invention and the multi-component resin systems according to the invention are used for the chemical fastening of anchoring means.

The present invention also relates to a method for the chemical fastening of construction elements in boreholes, a mortar composition according to the invention or a multi-component resin system according to the invention being used as described above for the chemical fastening of the construction elements. The method according to the invention is particularly suitable for the structural adhesion of concrete/concrete, steel/concrete or steel/steel or one of said materials with other mineral materials, for the structural strengthening of components made of concrete, brickwork and other mineral materials, for reinforcement applications with fiber-reinforced polymers of building objects, for the chemical fastening of surfaces made of concrete, steel or other mineral materials, in particular the chemical fastening of construction elements and anchoring means, such as anchor rods, anchor bolts, (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. The method according to the invention is very particularly preferably used for the chemical fastening of anchoring means.

The present invention also relates to the use of a multi-component resin system or a mortar composition according to the invention for the chemical fastening of construction elements in mineral substrates.

The invention also relates to the use of a multi-component resin system according to the invention or a mortar composition according to the invention for improving the pull-out strength of a chemical anchor produced from a multi-component resin system according to the invention boreholes. This includes in particular an increase in pull-out strengths in well-cleaned boreholes, well-cleaned meaning that the boreholes are repeatedly blown out with compressed air, then brushed out in order to loosen bore dust and cuttings adhering to the borehole wag, and then repeatedly blown out again with compressed air.

The invention also relates to the use of a molecular sieve in a multi-component resin system for chemical fastening in order to increase pull-out values.

The invention is described in greater detail below on the basis of embodiments which, however, should not be understood in a restrictive sense.

### EMBODIMENTS

The following compounds were used to prepare the comparative composition and the composition according to the invention:

| | | |
|---|---|---|
| Hexamethylene-1,6-diisocyanate | low-viscosity, aliphatic polyisocyanate resin | Covestro AG |
| homopolymers | based on hexamethylene diisocyanate | |
| | (equivalent weight approx. 179; NCO | |
| | content according to M105-ISO 11909 23.5 ± | |
| | 0.5 wt. %, monomeric HDI according to | |
| | M106-ISO 10283 <0.25%; viscosity (23° C.) | |
| | M014-ISO 3219/A.3 730 ± 100 mPa · s; | |
| | Desmodur ® N 3900) | |
| Hexamethylene-1,6-diisocyanate | Desmodur ® N 3200 | Covestro AG |
| biuret oligomerization product | | |
| Mixture of 6-methyl-2,4- | Ethacure ® 300 Curative | Albermale |
| bis(methylthio)phenylene-1,3- | (dimethylthiotoluene diamine 95-97%, | Corporation |
| diamine and 2-methyl-4,6- | monomethylthiotoluene diamine 2-3%; | |
| bis(methylthio)phenylene-1,3- | equivalent weight with isocyanates 107) | |
| diamine | | |
| Aspartic acid, N,N′-(methylenedi- | Desmophen ® NH 1420 | Covestro AG |
| 4,1-cyclohexanediyl)bis-,1,1′,4,4′- | (amine value M123-AFAM 2011-06054 199- | |
| tetraethyl ester | 203 mg KOH/g; equivalent weight approx. | |
| | 276; water content DIN 51777-1 ≤0.15%, | |
| | viscosity (25° C.) M068-DIN 53019 900- | |
| | 2,000 mPa · s)) | |
| 3- | Dynasylan ® GLYMO | Evonik Resource |
| glycidyloxypropyltrimethoxysilane | | Efficiency GmbH |
| Zeolite powder | Purmol ® 3ST (synthetic potassium-type | Zeochem AG |
| | zeolite having a pore size of 3 Å, a primary | |
| | crystal size of 4.6 μm and a particle size of | |
| | 24 μm; residual water (550° C. 2 h) ≤1.5% | |
| | w/w, water adsorption (50% rH, 20° C., | |
| | 24 h) ≥22% w/w) | |
| Quartz powder | Millisil ® W12 | Quarzwerke |
| | | Frechen |
| Silica | Cab-O-Sil ® TS-720 | Cabot |

The comparative compositions and the compositions according to the invention of the isocyanate component and the amine component are shown in Table 1 below.

TABLE 1
Compositions of the isocyanate component and the amine component [wt. %]
for comparative examples 1 to 3 and examples 1 and 2 according to the invention

| | Examples (weight proportions) | | | | |
|---|---|---|---|---|---|
| Constituent | Comparison 1 | Comparison 2 | 1 | Comparison 3 | 2 |
| Isocyanate component | | | | | |
| Hexamethylene-1,6-diisocyanate | 24.4 | 25.4 | 24.7 | 24.3 | 23.6 |
| homopolymer (N3900) | | | | | |
| Hexamethylene-1,6-diisocyanate | — | 4.1 | 4.0 | 4.0 | 3.9 |
| biuret oligomerization product | | | | | |
| (N3200) | | | | | |
| 3-glycidyloxypropyltrimethoxysilane | — | — | — | 2.0 | 2.0 |
| Quartz powder (W12) | 14.4 | 37.3 | 34.3 | 36.1 | 33.1 |
| Silica | 0.6 | 1.0 | 1.0 | 1.0 | 1.0 |
| Zeolite powder | — | — | 2.0 | — | 2.0 |
| Amine component | | | | | |
| 6-methyl-2,4- | | 17.4 | 16.0 | 17.6 | 17.1 |
| bis(methylthio)phenylene-1,3- | | | | | |
| diamine/2-methyl-4,6- | | | | | |
| bis(methylthio)phenylene-1,3- | | | | | |
| diamine | | | | | |
| Aspartic acid, N,N′-(methylenedi- | 37.6 | | | | |
| 4,1-cyclohexanediyl)bis-,1,1′,4,4′- | | | | | |
| tetraethyl ester | | | | | |
| Quartz powder | 22.1 | 14.3 | 16.7 | 14.5 | 16.9 |
| Silica | 0.9 | 0.5 | 0.5 | 0.5 | 0.5 |
| Volume ratio | | 2:1 | 2:1 | 2:1 | 2:1 |
| isocyanate component:amine | | | | | |
| component | | | | | |
| Isocyanate:amine ratio | 1:1 | 1:1 | 1.05:1 | 1:1 | 1.05:1 |
| Bond stress [N/mm²] | 26.0 | 27.5 | 30.2 | 30.3 | 33.1 |

To produce the comparative mortar mass 1, the isocyanate component and the amine component were each first produced individually. For this purpose, the constituents shown in Table 1 were combined and mixed in a speed mixer (DAC-600 from Hauschild) for 30 seconds at 1500 rpm. The isocyanate component and the amine component were then combined with one another and mixed in a speed mixer for 30 seconds at 1500 rpm. The mortar composition obtained in this way was filled into a single-component hard cartridge and injected into a borehole using an extrusion device.

To produce the comparative mortar composition 2 and the mortar compositions according to the invention, the isocyanate components and the amine components were each first produced individually. For this purpose, the constituents shown in Table 1 were combined and homogenized in a dissolver (PC Laborsystem GmbH, 8 min: 3500 rpm) under vacuum (80 mbar) to form an air-bubble-free pasty composition. The isocyanate component and the amine component were then combined with one another and mixed in a speed mixer for 30 seconds at 1500 rpm. The mortar compositions obtained in this way were each filled into a hard cartridge and injected into a borehole using an extrusion device.

To determine the bond stresses achieved with the mortar compositions, a high-strength threaded anchor rod M12 was used, which was doweled into a hammer-drilled borehole having a diameter of 14 mm and a borehole depth of 60 mm by means of the two-component mortar composition according to the invention in C20125 concrete slabs. To determine the reference bond stress, after a curing time of 24 hours at a temperature of 23° C. the failure load was determined by centrally pulling out the threaded anchor rod with close support. The mean failure load was determined from the results of five anchors.

The bond stresses obtained using the mortar formulations described above are listed in Table 1.

Both the formulations without 3-glycidyloxypropyltrimethoxysilane (comparison 1, example 1) and the formulations with 3-glycidyloxypropyltrimethoxysilane (comparison 2, example 2) show an improvement in bond stress of approx. 10% by adding 2% zeolite powder.

1. A multi-component resin system, containing:
an isocyanate component which comprises at least one aliphatic and/or aromatic polyisocyanate having an average NCO functionality of 2 or more, and
an amine component which comprises at least one amine which is reactive to isocyanate groups and has an average NH functionality of 2 or more,
with the proviso that the multi-component resin system is free of polyaspartic acid esters, the isocyanate component and, or the amine component comprising at least one filler and at least one rheology additive, and a total filling level of a mortar composition produced by mixing the isocyanate component and the amine component is in a range from 30 to 80 wt. %,
wherein the isocyanate component and/or the amine component additionally contains a molecular sieve.

2. The multi-component resin system according to claim 1, wherein the molecular sieve is a zeolite.

3. The multi-component resin system according to claim 2, wherein the zeolite is selected from the group consisting of
zeolte A (Na₁₂((AlO₂)₁₂(SiO₂)₁₂)·27 H₂O: K₁₂((AlO₂)₁₂(SiO₂)₁₂)·27 H₂O),
zeolite X (Na₈₆[(AlO₂)₈₆(SiO₂)₁₀₆]·264 H₂O),
zeolite Y (Na₅₆[(AlO₂)₅₆(SiO₂)₁₃₆]·250 H₂O),
zoolite L (K₉[(AlO₂)₉(SiO₂)₂₇]·22 H₂O),
mordenite (Na_{8 7}[(AlO₂)_{8 7}(SiO₂)_{39 3}]·24 H₂O),
zeolite ZSM 5 (Na_{0.3}H_{3.8}[(AlO₂)_{4.1}(SiO₂)_{91 9}]),
zeolite ZSM 11 (Na_{0.1}H_{1 7}[(AlO₂)_{1 8}(SiO₂)_{94.2}]).

4. The multi-component resin system according to claim 1, wherein the molecular sieve is present as a powder, granular material, or paste.

5. The multi-component resin system according to claim 1, wherein the molecular sieve is contained in an amount of 0.1 to 60 wt. %. based on a total weight of the multi-component resin system.

6. The multi-component resin system according to claim 1, wherein both the isocyanate component and the amine component comprise the at least one filler and the at least one rheology additive.

7. The multi-component resin system according to claim 6, wherein a filling level of the isocyanate component and a filling level of the amine component is from 10 to 70 wt. %. based in each case on a total weight of the isocyanate component and the amine component, respectively.

8. The multi-component resin system according to claim 1, wherein the at least one aliphatic and/or aromatic polyisocyanate and the at least one amine are present in a quantity ratio in which a ratio of the average NCO functionality of the at least one aliphatic and/or aromatic polyisocyanate to the average NH functionality of the at least one amine is between 0.3 and 2.0.

9. The multi-component resin system according to claim 1, wherein the isocyanate component comprises at least one aromatic polyisocyanate selected from the group consisting of 1,4-phenylene diisocyanate, 2,4- and/or 2,1-toluylene diisocyanate, xylylene diisocyanate, hydrogenated xylylene diisocyanate, tetramethylxylylene diisocyanate, 1,5-naphthylene diisocyanate, diphenylene methane-2,4′- and/or -4,4′-diisocyanate, triphenylmethane-4,4′,4″-triisocyanate, bis- and tris-(isocyanatoalkyl)-benzene, toluene, xylene, and mixtures thereof.

10. The multi-component resin system according to claim 1, wherein the isocyanate component comprises at least one aliphatic polyisocyanate selected from the group consisting of hexamethylene diisocyanate (HDI), trimethyl HDI (TMDI), pentane diisocyanate (PDI), 2-methylpentane-1,5-diisocyanate (MPDI), isophorone diisocyanate (IPDI), 1,3- and 1,4-bis(isocyanatomethyl)cyclohexane (H₆XDI), bis(isocyanatomethyl)norbornane (NBDI), 3(4)-isocyanatomethyl-1-methyl-cyclohexyl isocyanate (IMCI), 4,4′-bis(isocyanatocyclohexyl)methane (H₁₂MDI), and mixtures thereof.

11. The multi-component resin system according to claim 1, wherein the total filling level is in a range from 35 to 65 wt. %. based on a total weight of the multi-component resin system.

12. The multi-component resin system according to claim 1, wherein the at least one amine which is reactive to isocyanate groups is selected from the group consisting of 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine, 4,4′-methylenebis(2,6-diethylaniline), 4,4′-methylenebis(N-sec-butylcyclohexanamine), 3,3′-diaminodiphenylsulfone, N,N′-di-sec-butyl-p-phenylenediamine, 2,4,6-trimethyl-m-phenylenediamine, and mixtures thereof.

13. The multi-component resin system according to claim 1, wherein the multi-component resin system is a two-component resin system.

14. A mortar composition, produced by mixing the isocyanate component and the amine component of the multi-component resin system according to claim 1.

15. A method for chemical fastening of a construction element in a borehole, the method comprising:
curing the multi-component resin system according to claim 1 in the borehole, to chemically fasten the construction element.

16. A method for increasing the pull-out values of a chemical anchor, the method comprising:
mixing a molecular sieve into a multi-component resin system based on isocyanate amine adducts for chemical fastening.

17. A method for chemical fastening of a construction element in a mineral substrate, the method comprising:
curing the mortar composition according to claim 14 in the mineral substrate, to chemically fasten the construction element.
